(19) United States
(12) Patent Application Publication
(10) Pub. No.: US 2015/0135973 A1
(43) Pub. Date: May 21, 2015

(54) FILLED DOUGH PRODUCING APPARATUS AND METHOD

(71) Applicant: George Pul, Las Vegas, NV (US)

(72) Inventor: George Pul, Las Vegas, NV (US)

(21) Appl. No.: 14/081,368

(22) Filed: Nov. 15, 2013

(51) Int. Cl. A21C 9/06

(52) U.S. Cl. CPC A21C 9/063
USPC 99/450.6

(57) ABSTRACT

Filled dough producing method and apparatus is disclosed for making a food product, such as baozi, a traditional Chinese food, by folding and constricting close a circular dough wrapper around a filling in an apparatus including a pocket assembly made of pliable fabric layer with an upper surface and lower surface, a flexible frusto-conical annular member connected to the lower surface of the pliable fabric layer, and draw strings for making a pouch, wherein the frusto-conical annular member is configured to be alternately inverted from a first rigid position to a second rigid position.

### BACKGROUND OF THE INVENTION

Baozi is a traditional Chinese food made by folding a flat and circular yeast leavened dough sheet, a dough wrapper, around its filling, and is often steam cooked. The resulting baozi is ball shaped, has many folds at its upper body around the dough wrapper closure, and is smooth at the lower body.

Making a baozi traditionally by hand has been very much like making a handcraft that is time-consuming and requires a relatively high degree of both skill and labor. What is needed in the art is baozi producing apparatus suitable for the everyday consumers.

### SUMMARY OF THE INVENTION

The invention is generally directed to a filled dough producing method and apparatus which, among other things, greatly reduces both the skill and labor required to make a quality baozi.

Some embodiments of the invention are directed to a filled dough producing apparatus, comprising: a pliable fabric layer with an upper surface and lower surface; and a flexible frusto-conical annular member having a hole therein defining a radially inner periphery and a radially outer periphery, the frusto-conical annular member being connected along the radially inner periphery thereof to the lower surface of the pliable fabric layer, forming a filled dough receiving pocket on the upper surface of the pliable fabric layer, the pocket having a circular outer edge corresponding to the radially inner periphery of the frusto-conical annular member, wherein the frusto-conical annular member is corrugated and configured to be alternately inverted or reversed from a first rigid position in which the radially inner periphery is on a first side and a second rigid position in which the radially inner periphery is on a second side opposing the first side. The invention may further include means for causing the radially inward movement of the circular outer edge of the filled dough receiving pocket, and means for causing the frusto-conical annular member to move from the first rigid position to the second rigid position

In some embodiments, the means for causing the radially inward movement of the circular outer edge of the filled dough receiving pocket comprises one or more drawstrings connected with the frusto-conical annular member.

In some embodiments, the means for causing the frusto-conical annular member to move from the first rigid position to the second rigid position comprises an inner tubular member having a diameter corresponding to the inner periphery of the frusto-conical annular member and an outer tubular member including an outer radial rim, the outer tubular member having a diameter which is greater than the diameter of the inner tubular member, wherein the outer tubular member is operatively associated with the inner tubular member and configured for lateral movement axially along the exterior of the inner tubular member.

Some embodiments of the invention are directed to a method of producing a filled dough product by drawstrings is similar to a common drawstring pouch comprising the steps described below. A circular dough wrapper with its filling on top is placed on the apparatus pocket assembly in open position before drawstrings are pulled. The dough wrapper is then securely sandwiched in between the apparatus folds through its corrugated edge stiffener and folded close by the folding of the apparatus in close position. The folded dough wrapper enclosing its filling is further constricted to close to form a filled dough piece within the apparatus pouch after drawstrings are pulled. The completed filled dough is released from the apparatus when the drawstrings are released and the folding assembly is opened.

### BRIEF DESCRIPTION OF THE DRAWINGS

FIG. 1 is a perspective view of an apparatus which represents an embodiment of the invention in an open or receiving position.

FIG. 2 is an exploded view of the folding assembly of the embodiment shown in FIG. 1.

FIG. 3 is a top view of the embodiment shown in FIG. 1 in the closed position.

FIG. 4 is a cross section view of the embodiment shown in FIG. 1 taken along line 4-4 of FIG. 1, illustrating a baozi dough wrapper and its filling placed in the receiving pocket of the apparatus; and

FIG. 5 is cross section view of the embodiment shown in FIG. 1 taken along line 5-5 in FIG. 3, illustrating, among other things, the receiving pocket being constructed by pulling the drawstrings.

### DESCRIPTION OF THE PREFERRED EMBODIMENT

Embodiments of the invention fold and close a dough wrapper around its filling in producing a filled dough piece facilitated by the creation of a pouch around the dough wrapper through the apparatus described herein. An embodiment of the invention will now be described with reference to the drawings.

Unless otherwise apparent, or stated, directional references, such as “inner,” “inward,” “outer,” “outward,” “downward,” “upper”, “lower” etc., are for non-limiting descriptive purposes and intended to be relative to the orientation of a particular embodiment of the invention as shown in the view of that embodiment.

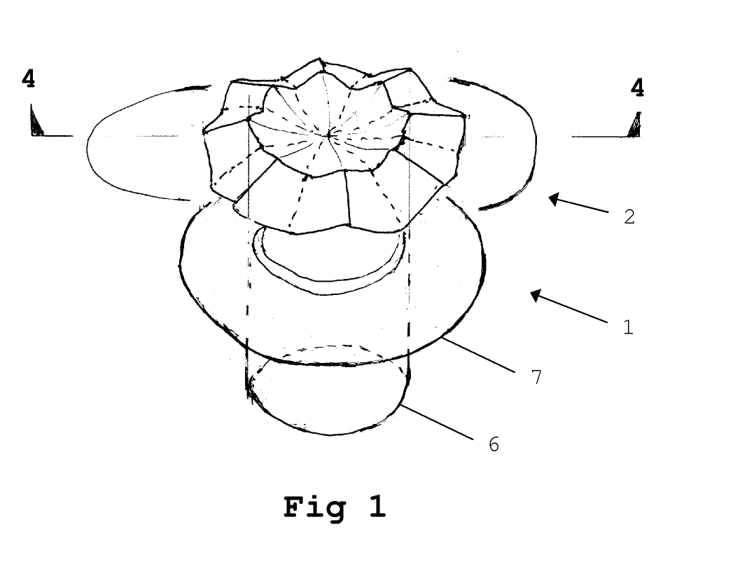

Referring to FIGS. 1-5, a filled dough producing apparatus 1 is shown in perspective view in the open position. Apparatus 1 comprises a folding assembly 2, a tubular guide chute 6, and a flanged pipe slider 7 having a greater diameter than the diameter of guide chute 6. Folding assembly 2 may be permanently or non-permanently mounted on guide chute 6, while flanged tube slider 7 is capable of lateral movement along the exterior surface of guide chute 6.

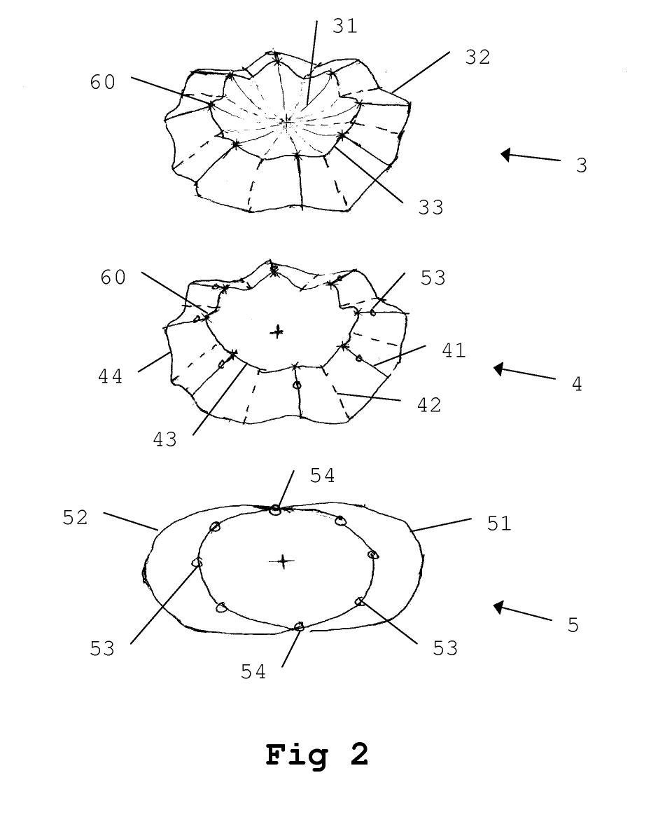

As shown particularly in FIG. 2, folding assembly 2 of this embodiment comprises a pocket assembly layer 3, a corrugated edge stiffener 4, and a device for causing the pocket assembly layer to move radially inward which in this embodiment includes drawstring assembly 5. Pocket assembly layer 3 is preferably made of a thin, lightweight and pliable material, such as a fabric. Pocket assembly layer 3 may be generally circular in shape and include a circular pocket 31 defined centrally within a surrounding radially outer border area or skirt 32 and facilitated by stiffener 4 as discussed herein. Corrugated edge stiffener 4 is a generally frusto-conical shaped annular member defining a hole therein having a radially inner periphery and a radially outer periphery. The corrugated edge stiffener 4 may be made of a resilient yet flexible material and includes alternating ridges and grooves to facilitate being reversed, that is, turned inside out, that is, alternately changed from a first rigid position in which the inner periphery edge 43 and outer periphery edge 44 are in a first, open or receiving configuration to a second rigid position in which the inner periphery edge 43 and outer periphery edge 44 are in a second or closed configuration that is the inverse of the first configuration. In other words, the inner and outer periphery edges 43 and 44 of stiffener 4 may be alternately folded downward and folded upward so that the inner and outer periphery may be positioned either with one up and the other down relative to one another. In this embodiment, there are eight symmetrical radial folding-lines identified by reference numerals 41 and 42, respectively, to illustrate the alternating radial ridges and grooves of stiffener 4. The radial ridges and grooves of corrugated edge stiffener 4 can be used to control the number and size of folds on a baozi dough wrapper 8 placed on the upper surface of layer 3.

The upper surface of corrugated edge stiffener 4 and lower surface of pocket assembly layer 3 are connected with one another along the radially inner peripheral edge 43 of stiffener 4, thus defining a circular filled dough receiving pocket 31 having an outer circumference 33 corresponding to the radially inner peripheral edge 43 of stiffener 4. In this embodiment, corrugated edge stiffener 4 may be connected to the lower surface of pocket assembly 3 by any conventional means, such as adhesive. As shown in FIG. 2, stiffener 4 and assembly layer 3 are connected at locations 60 which are equally spaced from one another along the radially inner peripheral edge 43 of stiffener 4. The eight connection points 60 also correspond with the eight radial ridges identified as folding lines 41 shown on stiffener 4.

The drawstring assembly 5 consists of two drawstring loops, 51 and 52, which are threaded through eight tie-down beads 53 positioned in a circular formation between the inner radial edge and outer radial edge of stiffener 4. In this embodiment, beads 53 are positioned along alternating ridge 41 at a radially outer position with respect to each of the connection points 60, and may be generally adjacent to the radial midpoint between inner and outer peripheral edges 43 and 44 of stiffener 4. Beads 53 include two diametrically opposed junction beads 54 for providing a common point for the two drawstrings loops 51 and 52. The drawstring assembly 5 is mounted between the upper surface of corrugated edge stiffener 4 and lower surface of pocket assembly layer 3. In other embodiments, there may be multiple sets of drawstrings and/or additional beads 53 positioned at various radial points along ridge 41 to form a lattice-type structure. In other embodiments, a belt or similar force applying and releasing apparatus other than a drawstring may be employed to cause the radially inward movement of stiffener 4 and the radial outer circumference 33 of pocket 31, and allow for the radially outward return of stiffener 4.

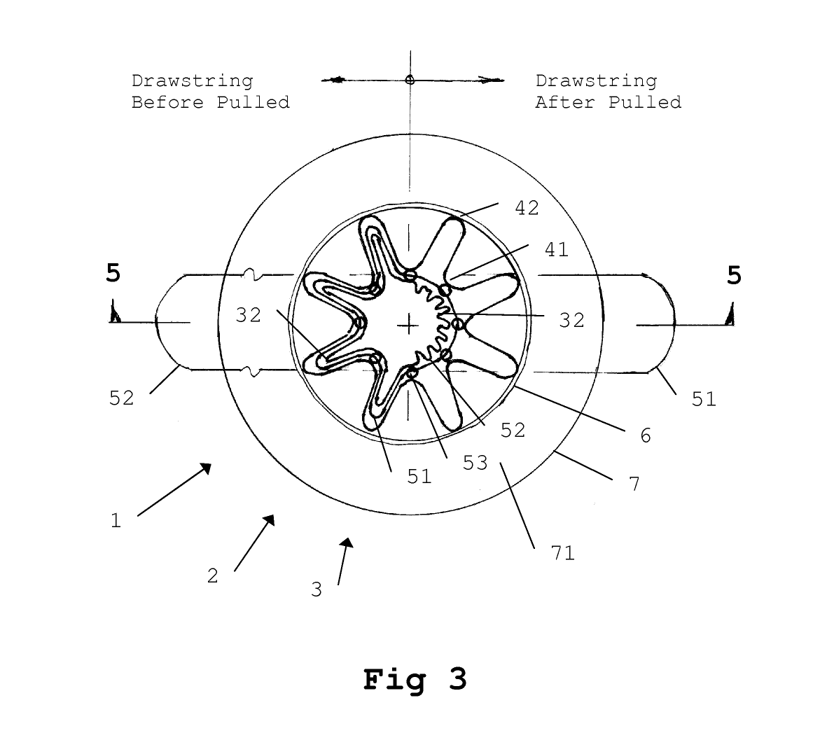

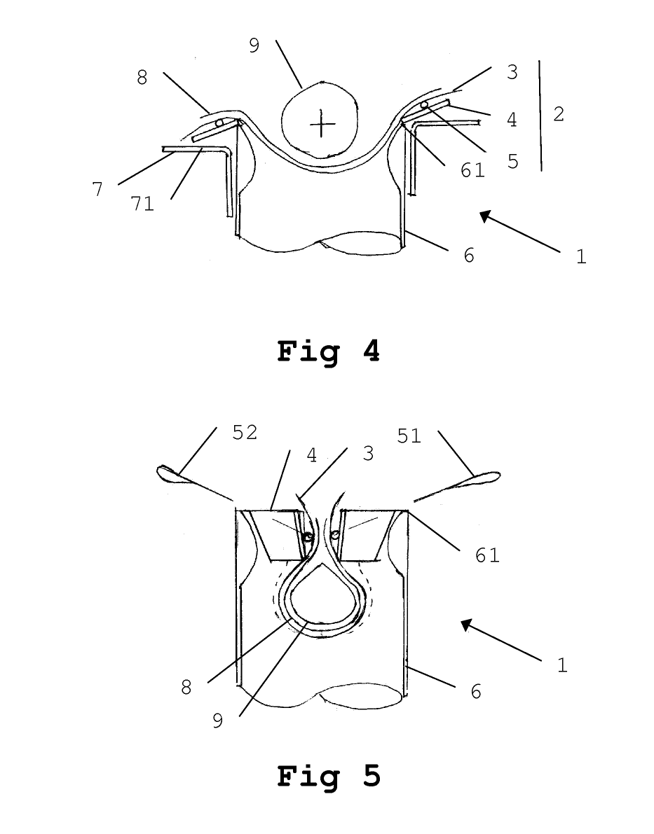

Referring to FIG. 3 where apparatus 1 is shown in plan view fully folded in the closed position with the outer circumference 33 of pocket 31 being forced radially inward to substantially and generally enclose pocket 31. As shown in FIG. 4, folding assembly 2 of this embodiment is supported by guide chute 6 having a substantially tubular shape. One end of guide chute 6 has an opening at one end 61 with a diameter corresponding to and in contact with the lower surface of the inner peripheral edge 43 of stiffener 4. While in contact with the lower surface of inner peripheral edge 43, pocket 31 extends or hangs axially within guide chute 6. In some embodiments, guide chute 6 may also have an integral opening reducer at end 61. A flanged tubular slider 7 having radially outer rim 71 is configured and dimensioned for lateral movement along the outer surface of guide chute 6 so that rim 71 may be brought into contact with the lower surface of stiffener 4 and facilitate switching stiffener 4 from the first position to the second position. In other embodiments, the force to cause stiffener to alternative from the first position or open configuration to the second position or closed configuration may be provided by other apparatus, such as radially outward extending arms connected to the stiffener 4.

In operation, a baozi dough wrapper 8 and its filling 9 are placed on the assembly 3 of apparatus 1 with the stiffener 4 in the first position or open configuration, that is, with inner peripheral edge 43 of stiffener 4 being axially above the outer peripheral edge 44 with respect to guide chute 6.

The dough wrapper 8 may be powdered on its underside where it is in contact with the pocket assembly layer 3 to facilitate the release and removal of the completed filled dough piece from contact with the upper surface of layer 3. The dough wrapper 8 may be un-powdered on the side which contacts filling 9 and will be closed upon itself in order to facilitate adhesion and closure of the dough wrapper 8 when folded together by the corrugated edge stiffener 4, and constricted close by the pulling of drawstrings.

As forces including the weight of the baozi dough wrapper 8 and its filling 9 in pocket assembly 3 cause pocket assembly 3 to move laterally downward, the flanged tube slider 7 is moved laterally upward axially along the chute 6 in the opposing direction, causing rim 71 to contact the lower surface of the corrugated edge stiffener 4 and force stiffener 4 into the second position or closed configuration. In the second position, inner peripheral edge 43 of stiffener 4 is axially below the outer peripheral edge 44 with respect to guide chute 6, causing pocket assembly 3 with baozi dough wrapper 8 and filling 9 therein to move axially down into the interior of chute 6.

Before drawstrings 51 and 52 are pulled, it should be noted that in this embodiment pocket assembly skirt 32 as well as baozi dough wrapper 8 are sandwiched in between the folds of the corrugated edge stiffener 4. As drawstring loop 51 and 52 are pulled, pocket assembly skirt 32 with baozi dough wrapper 8 are constricted to move inwardly and be completely pulled out from the folds of the corrugated edge stiffener 4. The pocket assembly 3 is constricted to form a pouch while portions of the baozi wrapper 8 are brought together around filling 9 thus forming a completed baozi as shown in FIG. 5. Guide chute 6, provides support for folding assembly 2 in the open configuration. Guide chute 6 also guides and promotes the folding action of folding assembly 2 via stiffener 4 moving from the first position to the second position as the weight of a wrapper 8 and filling 9 applies force to folding assembly 2 down chute 6. Chute 6 surrounds and supports the folding assembly 2 when in the closed configuration. Flanged tube slider 7, as it moves up and down the guide chute 6, provides means to snap over the folding assembly 2 from the first position to the second position. Continuing lifting of the folding assembly 2 with the completed baozi within, out and away from the confining guide chute 6, allows for the unfolding and opening of the folding assembly 2 and removal of the completed baozi.

As discussed herein, in some embodiments an apparatus of the invention includes a folding assembly made of a soft and pliable circular pocket assembly, a flexible corrugated edge stiffener attached to the pocket assembly, draw strings looped around and attached to the corrugated edge stiffener. In some embodiments, the apparatus is also provided with a guide chute that provides support, folding guide, and confinement of the folding assembly. Pulling the drawstrings constricts the folded pocket assembly and turning it into a ball shaped pouch. The drawstrings are then used to lift and remove the folding assembly from the guide chute. Releasing the drawstrings allow for the unfolding and opening of the folding assembly.

Thus the present method and apparatus may be employed in producing a filled dough piece like a traditional Chinese baozi. The method thus includes a circular yeast leavened dough wrapper with its filling on top being placed on the apparatus prior to folding the corrugated edge stiffener and before drawstrings are pulled. The dough wrapper folds and encloses its filling within the folded pocket assembly after the corrugated edge stiffener is folded and confined inside the guide chute. The folded dough wrapper with its enclosed filling is constricted to close as the folded pocket assembly is constricted to close into a pouch. After lifting and removing the folding assembly containing the completed baozi from the guide chute, releasing the drawstrings unfold and opens the apparatus folding assembly and releases the completed baozi. The apparatus may then be ready for a new dough wrapper and its filling to make the next baozi.

The apparatus includes features for holding open the folding assembly, inverting the corrugated edge stiffener between its two stable orientations, and to initiate folding operation. The corrugated edge stiffener defines the pouch major fold lines, and as the corrugated edge stiffener is folded, it also acts to hold the dough wrapper in place while folding it. The filled dough producing apparatus of some embodiments of the invention may be in the open position for placing a dough wrapper with its filling on the apparatus, or transitioning into the close position for folding the dough wrapper around its filling, or in the final closed position with the drawstrings pulled and the dough wrapper is fully folded and constricted close around its filling to produce a completed filled dough piece.

The embodiments described above are for the purpose of describing features and technical conceptions of both the method and apparatus of the invention, but it should be readily apparent that the invention is not limited to the described embodiments alone. A person skilled in the art may come up with various changes and modifications consistent to the technical concept disclosed herein and within the spirit and scope of the invention. Therefore, it is to be understood that modifications and variations may be utilized without departure from the spirit and scope of the invention disclosed herein, as those skilled in the art will readily understand. Such modifications and variations are considered to be within the purview and scope of the claims, recited elements and equivalents thereof.

What is claimed is:

1. A filled dough producing apparatus, comprising:
a) a pliable fabric layer with an upper surface and lower surface;
b) a flexible frusto-conical annular member defining a hole therein with a radially inner periphery and a radially outer periphery, the frusto-conical annular member being connected along the radially inner periphery thereof to the lower surface of the pliable fabric layer, forming a filled dough receiving pocket on the upper surface of the pliable fabric layer, the pocket having a circular outer edge corresponding to the radially inner periphery of the frusto-conical annular member, wherein the frusto-conical annular member is corrugated and configured to be alternately inverted from a first rigid position in which the radially inner periphery is on a first side and a second rigid position in which the radially inner periphery is on a second side opposing the first side;
c) means for causing the radially inward movement of the circular outer edge of the filled dough receiving pocket; and
d) means for causing the frusto-conical annular member to move from the first rigid position to the second rigid position.

2. A filled dough producing apparatus as recited in claim 1, wherein the means for causing the radially inward movement of the circular outer edge of the filled dough receiving pocket comprises one or more drawstrings connected with the frusto-conical annular member.

3. A filled dough producing apparatus as recited in claim 1, wherein the means for causing the frusto-conical annular member to move from the first rigid position to the second rigid position comprises an inner tubular member having a diameter corresponding to the inner periphery of the frusto-conical annular member and an outer tubular member including an outer radial rim, the outer tubular member having a diameter which is greater than the diameter of the inner tubular member, wherein the outer tubular member is operatively associated with the inner tubular member and configured for lateral movement axially along the exterior of the inner tubular member.
